(19) United States
(12) Patent Application Publication
(10) Pub. No.: US 2010/0272586 A1
(43) Pub. Date: Oct. 28, 2010

(54) Dust-Proof and Anti-Oil Leakage Structure for a Fan

(76) Inventors: Vicent HSU, DongGuan City (CN); Jack Lin, DongGuan City (CN); XueLiang Liu, DongGuan City (CN)

Correspondence Address: Dr. BANGER SHIA;Patent Office of Bang Shia, 102 Lindencrest Ct., Sugar Land, TX, 77479-5201, US

(21) Appl. No.: 12/503,383

(22) Filed: Jul. 15, 2009

(30) Foreign Application Priority Data
Apr. 24, 2009 (CN) 200920130930.3

(51) Int. Cl. F04D 25/08; H02K 5/10

(52) U.S. Cl. 417/354; 310/88

(57) ABSTRACT

A dust-proof and anti-oil leakage structure for a fan comprises a blade assembly, an outer frame and a center stator. On a spindle between the blade assembly and the outer frame are installed in sequence an outer frame, an upper insulating cover, a silicon steel lamination, a lower insulating cover, a printed circuit board heat sink, an elastic gasket with a cross hole, a washer, a copper sleeve, a round elastic gasket.

### BACKGROUND OF THE INVENTION

1. Field of the Invention

The present invention relates to a fan; and more particularly to a dust proof and anti-oil leakage structure for a direct-current brushless cooling fan.

2. Description of the Prior Art

A conventional direct-current brushless cooling fan essentially comprises a blade assembly, an outer frame and a center stator. Due to an unreasonable dust proof and anti-oil leakage structure, dust is prone to entering the interiors of the stator and bearings, and lubricant is prone to being thrown out, thus causing many drawbacks such as large noise, short service life, etc.

The present invention has arisen to mitigate and/or obviate the afore-described disadvantages.

### SUMMARY OF THE INVENTION

The primary objective of the present invention is to provide a dust-proof and anti-oil leakage structure for a direct current brushless cooling fan, which can effectively solve the drawbacks of the existing fans.

In order to achieve the above objective, a dust-proof and anti-oil leakage structure for a direct current brushless cooling fan essentially comprises a blade assembly, an outer frame and a center stator, wherein a spindle between the blade assembly and the outer frame is installed with in sequence a magnetic frame assembly, an upper insulating cover, a silicon steel lamination, a lower insulating cover, a PCB heat sink, an elastic gasket with a cross hole, a washer, a copper sleeve and an outer elastic cross gasket.

The anti-oil leakage structure of the present invention includes:

mating surfaces between the blade assembly and a bottom of the outer frame are sealed right-angled step mating surfaces;

the copper sleeve is defined with plural elongated grooves in an outer periphery thereof and plural helical grooves in each of two opposite ends thereof;

the elastic gasket with a cross hole is disposed on the spindle between the copper sleeve and the upper insulating cover;

the upper insulating cover with a stop ring is located on and pressed against the elastic gasket with a cross hole;

the blade assembly is reserved with a space in an inner side thereof for engaging with a protruding engaging portion at an inner side of the outer frame to form a sealed space;

the upper insulating cover is defined with an annular groove in an end thereof which is in contact with the inner side of the blade assembly, the blade assembly is provided with an annular ring on an end thereof which is in contact with the upper insulating cover, the annular ring is engaged in the annular groove; and

between an end of the copper sleeve and the bottom of the outer frame is provided the cross-shaped elastic gasket.

The dust-proof structure of the present invention includes:

the mating surfaces between the blade assembly and a bottom of the outer frame are the sealed right-angled step mating surfaces;

the upper insulating cover is defined with an annular groove in an end thereof which is in contact with the inner side of the blade assembly, the blade assembly is provided with an annular ring on an end thereof which is in contact with the upper insulating cover, the annular ring is engaged in the annular groove; and

the elastic gasket with a cross hole is disposed on the spindle between the copper sleeve and the upper insulating cover.

The dust-proof and anti-oil leakage structure for a direct current brushless cooling fan in accordance with the present invention is further characterized in that:

the bottom of the outer frame is defined with a groove, the second elastic gasket is an cross-shaped elastic gasket disposed between the end of the copper sleeve and the groove of the bottom of the outer frame;

the first elastic gasket is an elastic gasket with a cross hole, a portion of the spindle which is located at an outer side of the elastic gasket with a cross hole is coated with an anti-oil agent; and

a clearance in radius between an inner hole of the upper insulating cover and the spindle is smaller than 0.25 mm, a radius difference between an inner hole of the elastic gasket with a cross hole and the spindle is smaller than 0.2 mm.

Due to improvements to the dust-proof and anti-oil leakage structure and increase of the dust-proof and anti-oil leakage parts, the present invention has the following advantages such as fine dust-proof and anti-oil leakage effect, lower noise, long service life, etc.

### BRIEF DESCRIPTION OF THE DRAWINGS

FIG. 1 is an exploded view of a dust-proof and anti-oil leakage structure for a fan in accordance with the present invention;

FIG. 2 is a cross-sectional view of the dust-proof and anti-oil leakage structure for a fan in accordance with the present invention;

FIG. 3a is a cross sectional view of a copper sleeve for the dust-proof and anti-oil leakage structure for a fan in accordance with the present invention;

FIG. 3b is a left view of the copper sleeve for the dust-proof and anti-oil leakage structure for a fan of FIG. 3a in accordance with the present invention;

FIG. 3c is a right view of the copper sleeve for the dust-proof and anti-oil leakage structure for a fan of FIG. 3a in accordance with the present invention;

FIG. 3d is a cross sectional view of another copper sleeve for the dust-proof and anti-oil leakage structure for a fan in accordance with the present invention;

FIG. 3e is a right view of the copper sleeve for the dust-proof and anti-oil leakage structure for a fan of FIG. 3d in accordance with the present invention;

FIG. 3f is a perspective view of the copper sleeve for the dust-proof and anti-oil leakage structure for a fan of FIG. 3d in accordance with the present invention;

FIG. 4a is a front view of an upper insulating cover for the dust-proof and anti-oil leakage structure for a fan in accordance with the present invention;

FIG. 4b is a side view of the upper insulating cover for the dust-proof and anti-oil leakage structure for a fan in accordance with the present invention;

FIG. 4c is a cross sectional view of the upper insulating cover for the dust-proof and anti-oil leakage structure for a fan in accordance with the present invention;

FIG. 5 is a partial cross sectional view of the dust-proof and anti-oil leakage structure for a fan of FIG. 2 in accordance with the present invention showing a lubricating-oil loop;

FIG. 6 is a cross section view showing the dust-proof and anti-oil leakage structure for a fan in accordance with the present invention uses three dust-proof barriers I, II, III to stop the entry of the dust;

FIG. 7a is a schematic view of a round elastic gasket for the dust-proof and anti-oil leakage structure for a fan of FIG. 2 in accordance with the present invention;

FIG. 7b is a schematic view of an cross-shaped elastic gasket for the dust-proof and anti-oil leakage structure for a fan of FIG. 2 in accordance with the present invention; and

FIG. 8a is a schematic view showing a bottom of an outer frame for the dust-proof and anti-oil leakage structure for a fan of FIG. 2 in accordance with the present invention; and

FIG. 8b is a schematic view showing another bottom of the outer frame for the dust-proof and anti-oil leakage structure for a fan of FIG. 2 in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

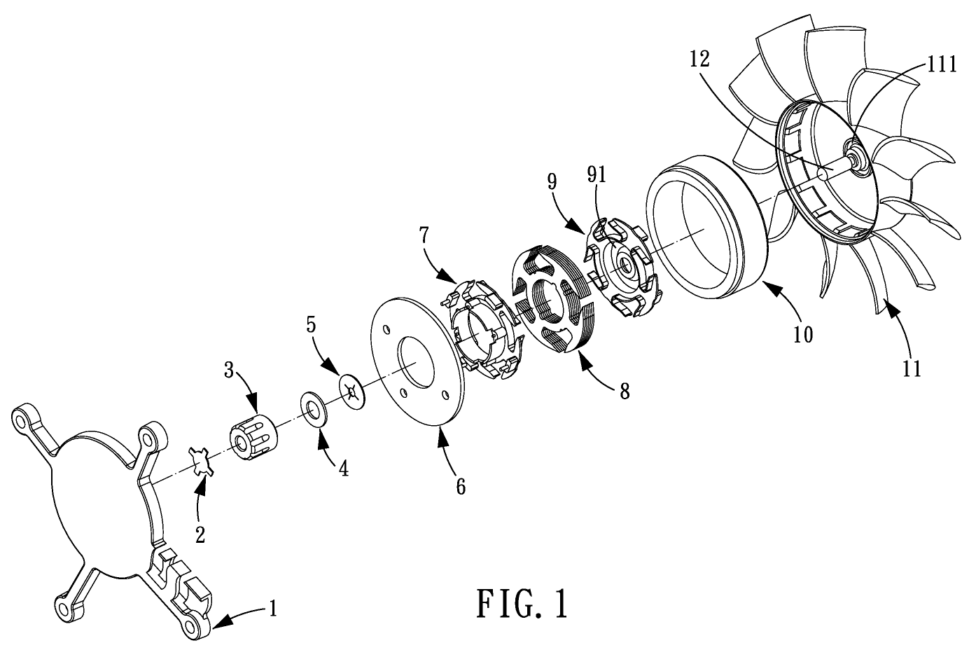

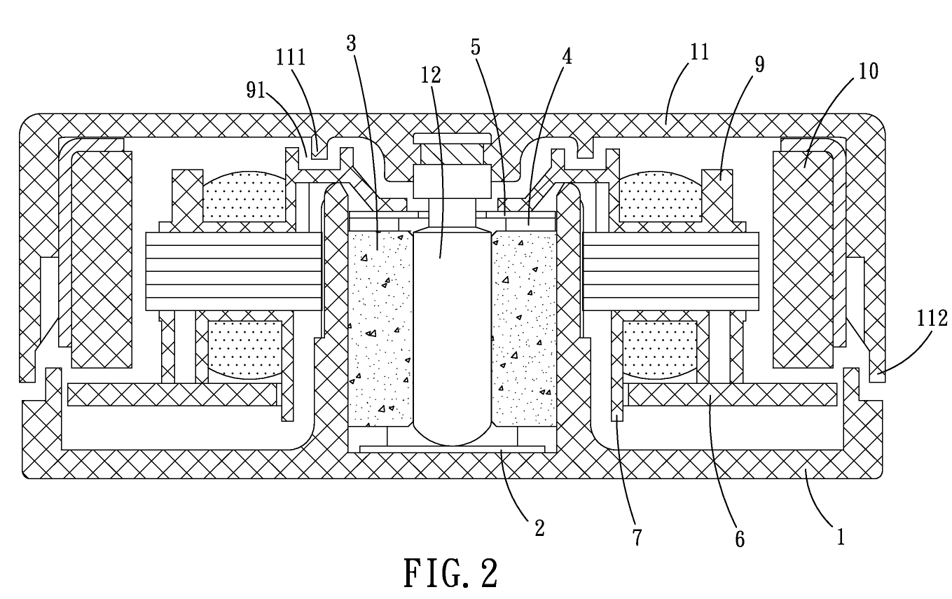

Referring to FIGS. 1-2, a dust-proof and anti-oil leakage structure for a fan in accordance with the present invention comprises a blade assembly 11, an outer frame 1, a spindle 12, a magnet frame assembly 10, an upper insulating cover 9, a silicon steel lamination 8, a lower insulating cover 7, a PCB (printed circuit board) heat sink 6, an elastic gasket 5 with a cross hole, a washer 4, a copper sleeve 3 and a cross-shaped elastic gasket 2.

The outer frame 1 has a bottom completely sealed to avoid oil leakage and adopts the down-draft design to keep the height of the product constant whenever the product is put on its side or upside down, avoiding many problems of the conventional structure which is assembled by using the magnetic suspension between rubber magnet and silicon steel sheets, such as the difficulties in controlling assembly size and product height, slow starting, abnormal noise, over-height, etc.

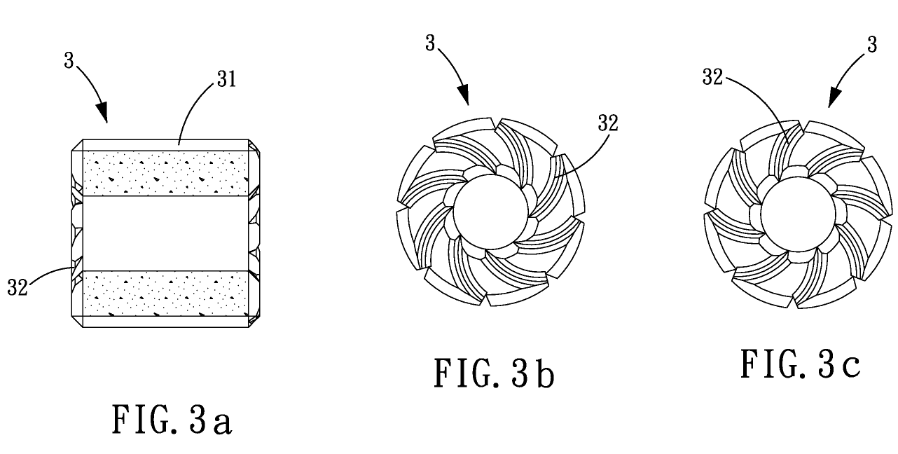

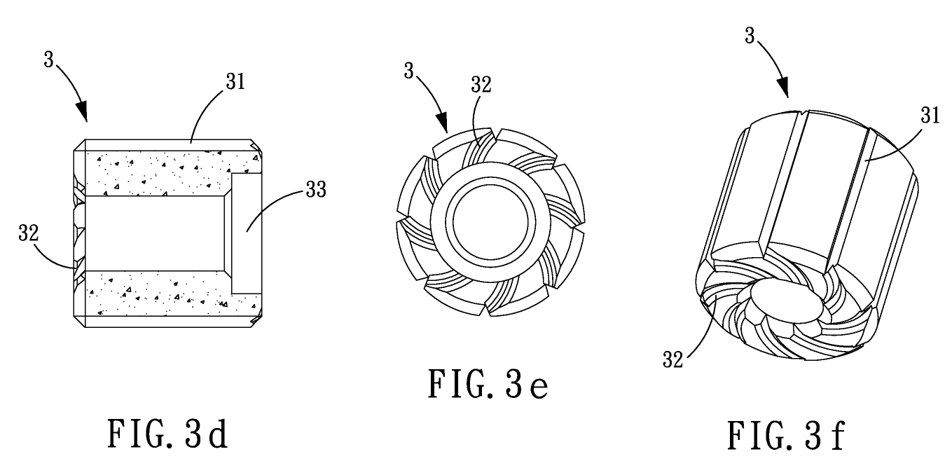

As shown in FIG. 3, the copper sleeve 3 is defined with plural helical grooves 32 in each of an upper surface and a lower surface thereof and plural elongated grooves 31 in an outer periphery thereof, thus forming a lubricant loop around the copper sleeve 3.

The spindle 12 is fastened to the blade assembly 11 (the elastic gasket 5 with a cross hole is located above the copper sleeve 3), since the elastic gasket 5 with a cross hole has an inner hole with a diameter smaller than an outer diameter of the spindle 12, the lubricant can be prevented from ascending and being thrown out.

The elastic gasket 5 with a cross hole is pressed and fixed by the upper insulating cover 9 provided with a retainer ring (not shown). In addition, the upper insulating cover 9 with the retainer ring also defines an inner relatively closed space for preventing the lubricant which ascends along the copper sleeve 3 from ascending and for enabling it to flow back.

A portion of the spindle 12, which is located above the elastic gasket 5 with a cross hole, is coated with an anti-oil agent 13 (a film type lubricant which will evaporate instantaneously after being coated on the spindle 12 and then form a film on a surface of the portion of the spindle 12, which can effectively isolate the lubricant) for stopping the oil from ascending and for enabling it to flow back.

The blade assembly 11 is defined with a space at an inner side of a hub thereof to cooperate with a hub of the outer frame 1 to define a relatively closed space for the center stator, thus effectively preventing it from the external foreign matters or dust.

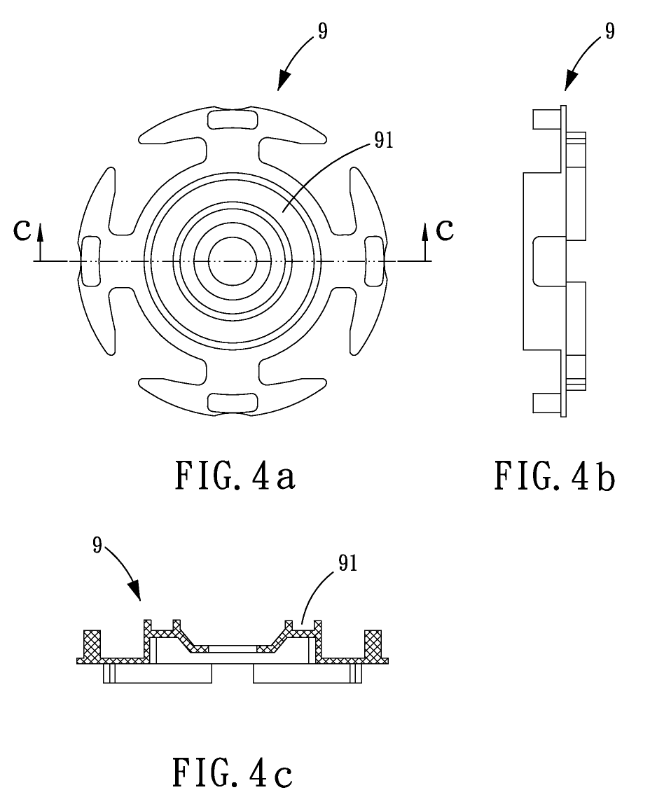

As shown in FIG. 4, the upper insulating cover 9 is defined with an upper annular groove 91 and cooperates with the protruding ring 111 of the blade assembly 11 to define a relative closed space for the spindle 12 and the copper sleeve 3, so as to prevent the remaining oil from being thrown out and the entry of the dust.

Referring to FIG. 3, the differences between the copper sleeve 3 of the present invention and a conventional copper sleeve are that: the copper sleeve 3 of the present invention is defined with the plural helical grooves 32 in each of the upper surface and the lower surface thereof the plural elongated grooves 31 in the outer periphery thereof, and this design can increase the oil storage space and define a lubricant loop around the copper sleeve 3, in addition, to add more oil storage space and make the copper sleeve press against the gasket at the bottom thereof tightly to avoid the occurrence of resonance sound caused by looseness of the gasket when the rotating speed is relatively high, the copper sleeve 3 is further defined in one end of an inner hole thereof with a big-diameter hole 33 , as shown in FIG. 3d. Due to the adding of the oil storage space, more lubricant gathers in the bottom of the spindle 12. When the fan is working, due to the increase of the atmospheric pressure in the copper sleeve, the lubricant will ascend along the spindle 12, so that more lubricant will be filled between the spindle and the bearings to keep the fan in a stable operating state. After the fan stops working, the lubricant will re-gather into the bottom of the spindle, thus ensuring the fan to work stably for a long time.

Referring to FIG. 4, the differences between the upper insulating cover 9 of the present invention and a conventional insulating cover are that: the upper insulating cover 9 of the present invention is defined with the annular groove 91 to cooperate with the protruding ring III of the blade assembly 11 to define the relatively closed space which is prevented from dust intrusion and lubricant leakage.

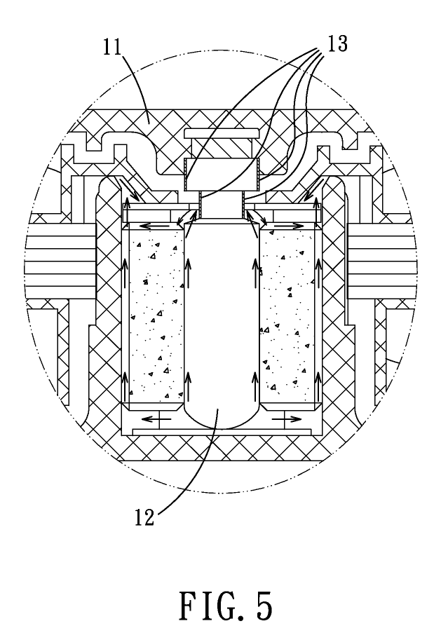

FIG. 5 illustrates a lubricant loop (shown by arrows) of the present invention, since the bottom of the outer frame 1 is sealed, no oil can be leaked from the bottom of the outer frame 1. When the fan is working, due to the increase of the atmosphere pressure in the copper sleeve 3, the lubricant will ascend along the spindle 12 or be thrown into the helical grooves 32 in the upper and lower surfaces of the copper sleeve 3 with the rotation of the spindle 12. When the lubricant ascends and reaches the elastic gasket 5 with a cross hole, since the diameter of the inner hole of the gasket 5 with a cross hole is smaller than the outer diameter of the spindle 12, a large amount of the lubricant will be stopped from ascending and then flow back, but a small amount of the lubricant will still ascend through the clearances between the grooves of the spindle 12 and the elastic gasket 5 with a cross hole. However, since the spindle 12 is coated with the anti oil agent 13 on the surface thereof above the cross gasket, the small amount of lubricant will also be stopped from ascending and then flow back, thus avoiding the leakage and throwing of the lubricant.

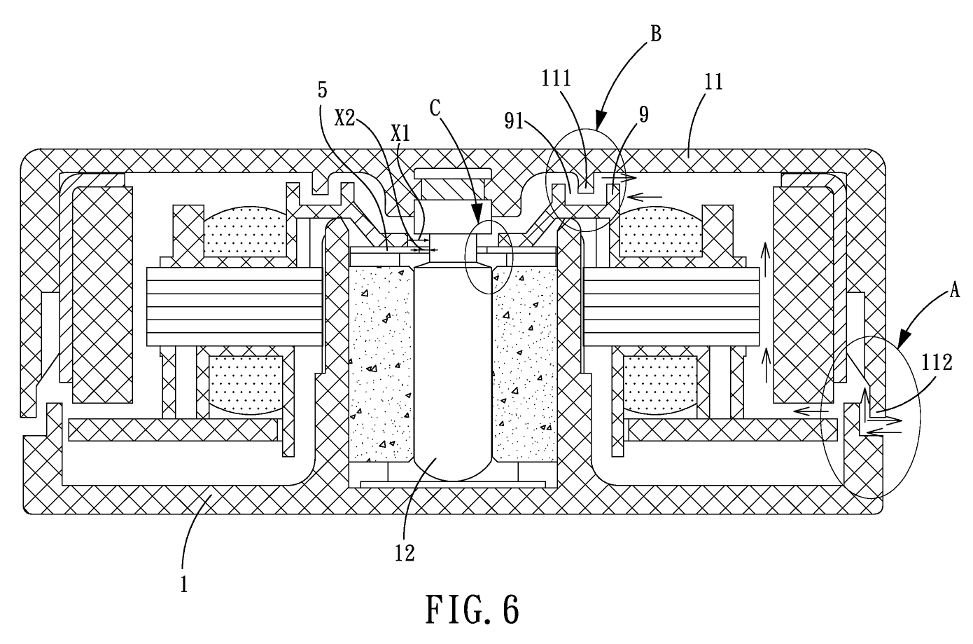

FIG. 6 illustrates that the dust is stopped from entering the interior of the fan of the present invention by three dust-proof barriers of the present invention I, II, III.

The blade assembly 11 is defined with the space at the inner side of the hub thereof to cooperate with the hub of the outer frame to define the relatively closed space for the center stator, which can completely stop the intrusion of foreign matters or particles with a diameter more than 0.3 mm, thus forming a first dust-proof barrier I.

The upper annular groove 91 of the upper insulating cover 9 cooperates with the protruding ring 111 of the blade assembly 11 to form a second dust-proof barrier II, which can effectively stop the intrusion of the dust from the stator into the spindle 12.

The clearance in radius between the inner hole of the upper insulating cover 9 and the spindle 12 is smaller than 0.25 mm, and the clearance in radius between the cross hole of the cross gasket and the spindle is smaller than 0.2 mm, thus forming a third dust-proof barrier III, which can completely stop the intrusion of the dust into the spindle.

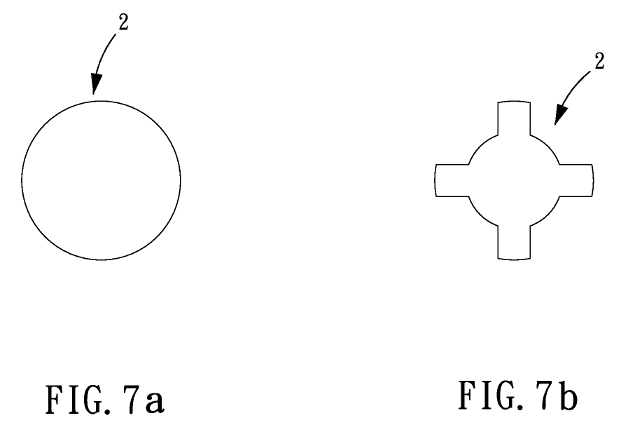

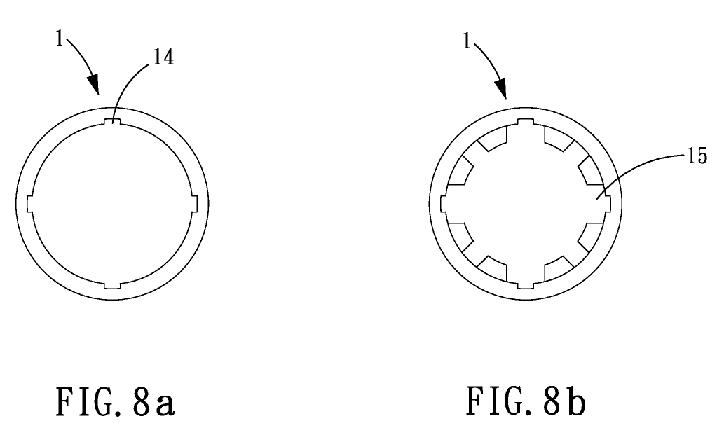

FIG. 7 illustrates two methods for sealing the bottom of the outer frame 1. The first method is to use a round elastic gasket 16 as shown in FIG. 7a in such a manner that the copper sleeve 3 directly presses against the round elastic gasket 16 to avoid the movement and the rotation of the gasket 16 as shown in FIG. 8a. The second method is to engage the cross-shaped elastic gasket 2 into a groove structure 15 of the outer frame 1 to avoid the rotation of the gasket 2 as shown in FIG. 8b, and the groove structure 15 can add more oil storage space.

FIG. 8 illustrates two sealed bottom structures for the outer frame 1, one is a structure which is centrally installed with the round elastic gasket 16 and defined with plural oil ways 14 in an inner periphery thereof; and the other is a structure which is centrally installed with the cross-shaped elastic gasket 2 engaged with the groove structure 15 and defined plural oil ways in an inner periphery thereof.

While we have shown and described various embodiments in accordance with the present invention, it is clear to those skilled in the art that further embodiments may be made without departing from the scope of the present invention.

What is claimed is:

1. A dust-proof and anti-oil leakage structure for a fan comprising: a blade assembly, an outer frame and a center stator, characterized in that: on a spindle between the blade assembly and the outer frame are installed in sequence an outer frame, an upper insulating cover, a silicon steel lamination, a lower insulating cover, a printed circuit board heat sink, an elastic gasket with a cross hole, a washer, a copper sleeve, a round elastic gasket or an cross-shaped elastic gasket, wherein:
mating surfaces between the blade assembly and a bottom of the outer frame are sealed right-angled step mating surfaces;
the copper sleeve is defined with plural elongated grooves in an outer periphery thereof and plural helical grooves in each of two opposite ends thereof;
the first elastic gasket is disposed on the spindle between the copper sleeve and the upper insulating cover;
the upper insulating cover with a stop ring is located on and pressed against the first elastic gasket;
the blade assembly is reserved with a space in an inner side thereof for engaging with a protruding engaging portion at an inner side of the outer frame to form a sealed space;
the upper insulating cover is defined with an annular groove in an end thereof which is in contact with the inner side of the blade assembly, the blade assembly is provided with an annular ring on an end thereof which is in contact with the upper insulating cover, the annular ring is engaged in the annular groove; and
between an end of the copper sleeve and the bottom of the outer frame is provided the second elastic gasket.

2. The dust-proof and anti-oil leakage structure for a fan as claimed in claim 1, characterized in that the bottom of the outer frame is defined with a groove, the second elastic gasket is an cross-shaped elastic gasket disposed between the end of the copper sleeve and the groove of the bottom of the outer frame.

3. The dust-proof and anti-oil leakage structure for a fan as claimed in claim 1, characterized in that the first elastic gasket is an elastic gasket with a cross hole, a portion of the spindle which is located at an outer side of the elastic gasket with a cross hole is coated with an anti-oil agent.

4. The dust-proof and anti-oil leakage structure for a fan as claimed in claim 1, characterized in that a clearance in radius between an inner hole of the upper insulating cover and the spindle is smaller than 0.25 mm, a radius difference between an inner hole of the elastic gasket with a cross hole and the spindle is smaller than 0.2 mm.
